(19) United States
(12) Patent Application Publication
(10) Pub. No.: US 2025/0066646 A1
(43) Pub. Date: Feb. 27, 2025

(54) ADHESIVE FILM, ADHESIVE SYSTEM, AND RELATED PROCESSES

(71) Applicant: 3M INNOVATIVE PROPERTIES COMPANY, St. Paul, MN (US)

(72) Inventors: Kerstin Unverhau, Neuss (DE); Silke D. Mechernich, Düsseldorf (DE); Frank Kuester, Düsseldorf (DE); Olaf W. van GAnsewinkel, Juechen (DE); Hans Peter Dette, Neuss (DE)

(21) Appl. No.: 18/720,807

(22) PCT Filed: Dec. 16, 2022
(86) PCT No.: PCT/IB2022/062405

§ 371 Date: Jun. 17, 2024

Related U.S. Application Data
(60) Provisional application No. 63/290,205, filed on Dec. 16, 2021.

(51) Int. Cl. C09J 133/08; C08F 220/06; C08F 220/14; C08F 220/18; C08F 222/10; C09J 5/08; C09J 133/12

(52) U.S. Cl. CPC C09J 133/08; C08F 220/06; C08F 220/14; C08F 220/1808; C08F 220/1811; C08F 222/102; C09J 5/08; C09J 133/12; C09J 2301/122; C09J 2301/208; C09J 2301/412; C09J 2400/14; C09J 2400/24; C09J 2433/003; C09J 2477/003

(57) ABSTRACT

An adhesive film includes a first (meth)acrylate copolymer containing at least 55 weight percent (wt. %) of linear or branched alkyl (meth)acrylate monomer units, from 15 to 40 wt. % of (meth)acrylic acid monomer units, and 0.1 to 5 wt. % of monomer units of a crosslinking monomer having more than one (meth)acrylate group. If the first (meth)acrylate copolymer comprises 15 wt. % (meth)acrylic acid monomer units, the first (meth)acrylate copolymer comprises at least five wt. % monomer units of a high T_{g} monomer. The adhesive film comprises not more than five wt. % of a further (meth)acrylate copolymer comprising from 0.1 to 15 wt. % of (meth)acrylic acid monomer units. The adhesive film can be a multilayer adhesive assembly including a first layer of the first (meth)acrylate copolymer and a second adhesive layer adjacent to the first layer. A process for making and a system including the adhesive film and a primer are also described.

### CROSS-REFERENCE TO RELATED APPLICATION

This application claims the benefit of U.S. Application No. 63/290,205, filed Dec. 16, 2021, the disclosure of which is incorporated by reference in its entirety herein.

### BACKGROUND

Adhesives have been used for a variety of marking, holding, protecting, sealing, and masking purposes. Adhesive tapes generally comprise a backing, or substrate, and an adhesive. One type of adhesive which is useful for many applications is a pressure sensitive adhesive. Pressure sensitive adhesives (PSAs) are well known to one of ordinary skill in the art to possess certain properties including the following: (1) aggressive and permanent tack, (2) adherence with no more than finger pressure, (3) sufficient ability to hold onto an adhered, and (4) sufficient cohesive strength.

Materials that have been found to function well as pressure sensitive adhesives are polymers designed and formulated to exhibit the requisite viscoelastic properties resulting in a desired balance of tack, peel adhesion, and shear strength. The most commonly used polymers for preparation of pressure sensitive adhesives are various (meth)acrylate-based copolymers, natural rubber, synthetic rubbers, and silicones.

A pressure sensitive adhesive composition comprising a combination of a first (meth)acrylate copolymer and a second (meth)acrylate copolymer is reported to exhibit high adhesive peel and shear strength on various types of substrates in U.S. Pat. Appl. Pub. No. 2021/0102099 (Unverhau et al.). A multilayer pressure sensitive adhesive assembly comprising a first pressure sensitive adhesive layer superimposed on a second pressure sensitive adhesive layer is reported to exhibit high adhesive peel and shear strength on various types of substrates in U.S. Pat. No. 9,845,414 (Wieneke et al.).

### SUMMARY

After application to a substrate surface, pressure sensitive adhesives (PSAs) typically flow and wet the surface in order to create adhesion. The Dahlquist criterion is commonly used to describe such behavior of PSAs. The Dahlquist criterion for a PSA suggests that the shear Storage Modulus G′ should not exceed 0.3 megapascal (MPa) at 25° C. applying an oscillatory strain at 1 hertz (Hz) within the linear viscoelastic region of the PSA. If the Dahlquist criterion is exceeded, PSAs usually lose their tackiness, and adhesion build-up no longer takes place properly. Thus, the Dahlquist criterion represents an upper limit of the storage modulus for obtaining PSA properties. However, with such a limit of storage modulus, the overall cohesive strength of PSAs is limited as well, commonly not exceeding 1 MPa overlap shear strength.

The present disclosure provides adhesive films that exceed the Dahlquist criterion but in combination with a primer provide excellent wetting adhesion to substrates. The adhesive film in combination with primer can provide overlap shear strength values from 2.5 MPa to 3.5 MPa as shown in the Examples, below. Thus, the adhesive film of the present disclosure has excellent cohesive strength and can provide overlap shear adhesive values much higher than typical PSAs. In the presence of a primer, the adhesive film of the present disclosure functions as a PSA according to the properties (1) to (4) described above. Advantageously, with the ability to function as a PSA, no heat or radiation and reactive chemistry in the primer or adhesive film are necessary to provide the beneficial adhesive properties.

According to one aspect, the present disclosure relates to an adhesive film that includes a first (meth)acrylate copolymer containing at least 55 weight percent of linear or branched alkyl (meth)acrylate monomer units, based on the weight of the (meth)acrylate copolymer, from 15 weight percent to 40 weight percent of (meth)acrylic acid monomer units, based on the weight of the (meth)acrylate copolymer, and 0.1 weight percent to 5 weight percent of monomer units of a crosslinking monomer having more than one (meth)acrylate group, based on the weight of the (meth)acrylate copolymer. If the first (meth)acrylate copolymer comprises 15 weight percent (meth)acrylic acid monomer units, the first (meth)acrylate copolymer comprises at least five weight percent monomer units of a high T_{g} monomer that when homopolymerized provides a homopolymer having a glass transition temperature of at least 50° C., based on the weight of the first (meth)acrylate copolymer. The adhesive film includes not more than five percent by weight of a further (meth)acrylate copolymer having from 0.1 weight percent to 15 weight percent of (meth)acrylic acid monomer units, based on the weight of the further (meth)acrylate copolymer.

The adhesive film of the present disclosure may be in the form of a foam and/or may form part of a multilayer adhesive assembly, wherein the adhesive film is in the form of a first adhesive layer, which may be a foam layer, and wherein the multilayer adhesive assembly further comprises a second adhesive layer adjacent to the first adhesive layer.

According to another aspect, the adhesive film is a multilayer adhesive assembly comprising a first layer of the first (meth)acrylate copolymer and a second adhesive layer adjacent to the first layer.

In some embodiments, the adhesive film further includes a second (meth)acrylate copolymer having from greater than 15 weight percent to 40 weight percent of (meth)acrylic acid monomer units, based on the weight of the second (meth)acrylate copolymer. In another aspect, the present disclosure provides a process for manufacturing such an adhesive film. The process includes incorporating the second (meth)acrylate copolymer into a curable precursor composition comprising the linear or branched alkyl (meth)acrylate monomer, the (meth)acrylic acid monomer, the crosslinking monomer, and a polymerization initiator and polymerizing the linear or branched alkyl (meth)acrylate monomer, the (meth)acrylic acid monomer, the crosslinking monomer to form the first (meth)acrylate copolymer in the presence of the second (meth)acrylate copolymer.

In still another aspect, the present disclosure provides an adhesive system including a primer composition and the aforementioned adhesive film, in which the adhesive film does not react with the primer composition to form covalent bonds.

In the context of the present disclosure, the expression “low surface energy substrates” is meant to refer to those substrates having a surface energy of less than 34 dynes per centimeter. Included among such materials are polypropylene (PP), polyethylene (e.g., high density polyethylene (HDPE)), and blends of polypropylene (e.g., PP/ethylene propylene diene monomer (EPDM), thermoplastic olefin (TPO)).

In the context of the present disclosure, the expression “medium surface energy substrates” is meant to refer to those substrates having a surface energy comprised between 34 and 70 dynes per centimeter, typically between 34 and 60 dynes per centimeter, and more typically between 34 and 50 dynes per centimeter. Included among such materials are polyamides (PA) such as polyamide 6 (PA6), acrylonitrile butadiene styrene (ABS), polycarbonate (PC)/ABS blends, PC, polyvinyl chloride (PVC), PUR, thermoplastic elastomers (TPE), polyoxymethylene (POM), polystyrene, poly(methyl methacrylate) (PMMA), clear coat surfaces, in particular clear coats for vehicles like a car or coated surfaces for industrial applications and composite materials like fiber reinforced plastics.

In the context of the present disclosure, the expression “high surface energy substrates” is meant to refer to those substrates having a surface energy of more than 350 dynes per centimeter, typically more than 400 dynes per centimeter, and more typically to those substrates having a surface energy comprised between 400 and 1100 dynes per centimeter. Included among such materials are metal substrates (e.g., aluminum, stainless steel), and glass.

The surface energy is typically determined from contact angle measurements as described, for example, in ASTM D7490-08.

The term superimposed, as used throughout the description, means that two or more layers of the liquid precursors of the polymers or of the polymer layers of the multilayer adhesive assembly, are arranged on top of each other. Superimposed liquid precursor layers or polymer layers may be arranged directly next to each other so that the upper surface of the lower layer is abutting the lower surface of the upper layer.

The term adjacent, as used throughout the description, refers to two superimposed layers within the precursor multilayer adhesive assembly or the cured multilayer adhesive assembly which are arranged directly next to each other, i.e., which are abutting each other.

The terms “glass transition temperature” and “Tg” are used interchangeably and refer to the glass transition temperature of a (co)polymeric material or a mixture. Unless otherwise indicated, glass transition temperature values are determined by Dynamic Mechanical Analysis (DMA).

Exemplary “wet-in-wet” production processes for use herein are described in detail in e.g. WO-A1-2011094385 (Hitschmann et al.) or in EP-A1-0259094 (Zimmerman et al.), the full disclosures of which are herewith incorporated by reference.

The term “acrylic” refers to both acrylic and methacrylic polymers, oligomers, and monomers.

The term “(meth)acrylate” with respect to a monomer, oligomer, or polymer means a vinyl-functional alkyl ester formed as the reaction product of an alcohol with an acrylic or a methacrylic acid. “(Meth)acrylate” includes, separately and collectively, methacrylate and acrylate.

The term “polymer” refers to a molecule having a structure which includes the multiple repetition of units derived, actually or conceptually, from one or more monomers. The term “monomer” refers to a molecule of low relative molecular mass that can combine with others to form a polymer. The term “polymer” includes homopolymers and copolymers, as well as homopolymers or copolymers that may be formed in a miscible blend, e.g., by coextrusion or by reaction. The term “polymer” includes random, block, graft, and star polymers. The term “polymer” encompasses oligomers.

A “monomer unit” of a polymer or oligomer is a segment of a polymer or oligomer derived from a single monomer.

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent. The term “crosslinked” includes partially crosslinked.

The term “alkyl” refers to a monovalent group which is a saturated hydrocarbon. The alkyl can be linear, branched, cyclic, or combinations thereof and typically has 1 to 32 carbon atoms. In some embodiments, the alkyl group contains 1 to 25, 1 to 20, 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, 2-ethylhexyl, 2-octyl and 2-propylheptyl.

As used in this specification and the appended claims, the term “or” is generally employed in its sense including “and/or” unless the content clearly dictates otherwise.

As used herein, “have”, “having”, “include”, “including”, “comprise”, and “comprising” are used in their open ended sense, and generally mean “including, but not limited to.” It will be understood that the terms “consisting of” and “consisting essentially of” are subsumed in the term “comprising”.

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g., 1 to 5 includes 1, 1.5, 2, 2.75, 3, 3.8, 4, and 5, and the like).

The above summary of the present disclosure is not intended to describe each disclosed embodiment or every implementation of the present disclosure. The description that follows more particularly exemplifies illustrative embodiments. It is to be understood, therefore, that the following description are for illustration purposes only and should not be read in a manner that would unduly limit the scope of this disclosure.

### DETAILED DESCRIPTION

In the adhesive film of the present disclosure, the first (meth)acrylate copolymer comprises at least 55 weight percent of linear or branched alkyl (meth)acrylate monomer units, based on the weight of the first (meth)acrylate copolymer. In some embodiments, the first (meth)acrylate copolymer comprises at least 60, 65, or 70 weight percent (wt %) of linear or branched alkyl (meth)acrylate monomer units, based on the weight of the first (meth)acrylate copolymer. In some embodiments, the first (meth)acrylate copolymer comprises less than 85 weight percent or up to 84, 83, 82, 81, or 80 weight percent of linear or branched alkyl (meth)acrylate monomer units, based on the weight of the first (meth)acrylate copolymer. In some embodiments, when present, the second (meth)acrylate copolymer comprises at least 55, 60, 65, or 70 weight percent of linear or branched alkyl (meth)acrylate monomer units, based on the weight of the second (meth)acrylate copolymer. In some embodiments, the second (meth)acrylate copolymer comprises less than 85 weight percent or up to 84, 83, 82, 81, or 80 weight percent of linear or branched alkyl (meth)acrylate monomer units, based on the weight of the first (meth)acrylate copolymer. In some embodiments, the linear or branched alkyl (meth)acrylate monomer units are C₁-C₃₂ (meth)acrylic acid ester monomer units, C₁-C₂₄ (meth)acrylic acid ester monomer units, or C₁-C₁₈(meth)acrylic acid ester monomer units.

Examples of suitable alkyl (meth)acrylates include those represented by Formula I:

CH₂═C(R′)COOR (I)

wherein R′ is hydrogen or a methyl group and R is an alkyl group having 1 to 30, 4 to 30, 6 to 30, 8 to 30, 6 to 24, 6 to 20, 6 to 18, 8 to 24, 8 to 20, or 8 to 20 carbon atoms and may be linear or branched. Examples of suitable monomers represented by Formula I include methyl (meth)acrylate, ethyl (meth)acrylate, n-propyl (meth)acrylate, isopropyl (meth)acrylate, n-butyl acrylate, isobutyl acrylate, tert-butyl (meth)acrylate, n-pentyl (meth)acrylate, iso-pentyl (meth)acrylate, n-hexyl (meth)acrylate, iso-hexyl (meth)acrylate, octyl (meth)acrylate, iso-octyl (meth)acrylate, 2-octyl(meth)acrylate, 2-ethylhexyl (meth)acrylate, decyl (meth)acrylate, isodecyl acrylate, undecyl (meth)acrylate, n-dodecyl acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, 2-propylheptyl (meth)acrylate, stearyl (meth)acrylate, n-nonyl (meth)acrylate, isononyl (meth)acrylate, isomyristyl (meth)acrylate, isostearyl (meth)acrylate, octadecyl (meth)acrylate, and behenyl (meth)acrylate. Suitable monomer units further include mixtures of at least two or at least three structural isomers of a secondary alkyl (meth)acrylate of Formula II:

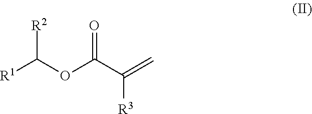

wherein R¹ and R² are each independently a C₁ to C₃₀ saturated linear alkyl group; the sum of the number of carbons in R¹ and R² is 7 to 31; and R³ is H or CH₃. The sum of the number of carbons in R¹ and R² can be, in some embodiments, 7 to 27, 7 to 25, 7 to 21, 7 to 17, 7 to 11, 7, 11 to 27, 11 to 25, 11 to 21, 11 to 17, or 11. Methods for making and using such monomers and monomer mixtures are described in U.S. Pat. No. 9,102,774 (Clapper et al.).

In some embodiments, the first (meth)acrylate copolymer and/or the optional second (meth)acrylate copolymer, comprise at least one of 2-ethylhexyl (meth)acrylate, 2-propylheptyl (meth)acrylate, iso-octyl (meth)acrylate. In some embodiments, the first (meth)acrylate copolymer and/or the second (meth)acrylate copolymer comprises 2-ethylhexyl (meth)acrylate.

In the adhesive film of the present disclosure, the first (meth)acrylate copolymer comprises from 15 weight percent to 40 weight percent of (meth)acrylic acid monomer units. In some embodiments, the first (meth)acrylate copolymer comprises (meth)acrylic acid monomer units in an amount of at least 15 wt %, greater than 15 wt %, at least 16 wt %, or at least 17 wt %, based on the weight of the first (meth)acrylate copolymer. In some embodiments, when present, the second (meth)acrylate copolymer in the adhesive film comprises greater than 15 weight percent to 40 weight percent of (meth)acrylic acid monomer units. In some embodiments, the second (meth)acrylate copolymer comprises (meth)acrylic acid monomer units in an amount greater than 15 wt %, at least 16 wt %, or at least 17 wt %, based on the weight of the second (meth)acrylate copolymer. In some embodiments, the first (meth)acrylate copolymer in the adhesive film comprises from 15.5 to 40 wt %, 16 to 40 wt %, from 16 to 35 wt %, from 16 to 30 wt %, from 16 to 25 wt %, from 17 to 25 wt %, from 17 to 23 wt %, or from 17 to 20 wt % of (meth)acrylic acid monomer units, based on the weight of the first (meth)acrylate copolymer. In some embodiments, the optional second (meth)acrylate copolymer in the adhesive film comprises from 15.5 to 40 wt %, 16 to 40 wt %, from 16 to 35 wt %, from 16 to 30 wt %, from 16 to 25 wt %, from 17 to 25 wt %, from 17 to 23 wt %, or from 17 to 20 wt % of (meth)acrylic acid monomer units, based on the weight of the second (meth)acrylate copolymer. Examples of (meth)acrylic acid monomer units include acrylic acid, methacrylic acid, itaconic acid, maleic acid, fumaric acid, ethacrylic acid, crotonic acid, citraconic acid, cinnamic acid, beta-carboxy ethyl acrylate, and 2-methacrylolyloxyethyl succinate. In some embodiments, the (meth)acrylic acid monomer units are acrylic acid monomer units or methacrylic acid monomer units. (Meth)acrylic acid monomer units encompass salts of these acids, such as alkali metal salts and ammonium salts.

In some embodiments, the first (meth)acrylate copolymer further comprises monomer units of a “high T_{g}” monomer that when polymerized provides a homopolymer having a glass transition temperature (T_{g}) of at least 50° C., 60° C., or 70° C. (i.e., a homopolymer formed from the monomer has a T_{g} at least 50° C., 60° C., or 70° C.). In embodiments in which the first (meth)acrylate copolymer has 15 wt % (meth)acrylic acid monomer units, based on the weight of the first (meth)acrylate copolymer, the the first (meth)acrylate copolymer further comprises at least 5 wt % (in some embodiments, at least 7.5, 10, 12.5 or 15 wt %) monomer units of a “high T_{g}” monomer. The T_{g} of the homopolymers are measured by Differential Scanning Calorimetry, and many are reported in the Polymer Properties Database found at polymerdatabase.com. Some suitable high T_{g} monomers include methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, phenyl acrylate, benzyl methacrylate, 3,3,5 trimethylcyclohexyl (meth)acrylate, tert-butyl cyclohexyl methacrylate, 2-phenoxyethyl methacrylate, N-octyl (meth)acrylamide, tetrahydrofurfuryl methacrylate, and mixtures thereof. Other suitable high T_{g} monomers have a single vinyl group that is not a (meth)acryloyl group such as various vinyl ethers (e.g., vinyl methyl ether), vinyl esters (e.g., vinyl acetate and vinyl propionate), styrene, substituted styrene (e.g., α-methyl styrene), vinyl halide, and mixtures thereof. In some embodiments, the optional second (meth)acrylate copolymer further comprises monomer units of a high T_{g} monomer, including any of those described above in any of the weight percentages described above.

In the adhesive film of the present disclosure, the first (meth)acrylate copolymer includes 0.05 weight percent to 5 weight percent of monomer units of a crosslinking monomer having more than one (meth)acrylate group, based on the weight of the (meth)acrylate copolymer. Suitable crosslinking monomers include diacrylate esters of diols, such as ethylene glycol diacrylate, diethylene glycol diacrylate, propanediol diacrylate, butanediol diacrylate, butane-1,3-diyl diacrylate, pentanediol diacrylate, hexanediol diacrylate (including 1,6-hexanediol diacrylate), heptanediol diacrylate, octanediol diacrylate, nonanediol diacrylate, decanediol diacrylate, and dimethacrylates of any of the foregoing diacrylates. Further suitable polyfunctional monomers include polyacrylate esters of polyols, such as glycerol triacrylate, dipropylene glycol diacrylate, tripropylene glycol diacrylate, trimethylolpropane triacrylate, pentaerythritol tetraacrylate, neopentyl glycol diacrylate, dipentaerythritol pentaacrylate, methacrylates of the foregoing acrylates, and combinations thereof. Further suitable polyfunctional crosslinking monomers include divinyl benzene, allyl methacrylate, diallyl maleate, diallyl phthalate, and combinations thereof. Further suitable polyfunctional crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof. Combinations of any of these crosslinking monomers may be useful. In some embodiments, up to 4, 3, 2, or 1 percent by weight of monomer units in the first (meth)acrylate copolymer are derived from crosslinking monomers. In some embodiments, at least 0.1 percent by weight of monomer units in the first (meth)acrylate copolymer are derived from crosslinking monomers. The second (meth)acrylate copolymer, when present, may be free of crosslinking monomer units.

An acrylic polymer can be analyzed by nuclear magnetic resonance spectroscopy (¹H or ¹³C NMR) to identify the monomer units in the polymer. Solid state or solution NMR may be useful depending on the level of crosslinking in the polymer. For solid state NMR the acrylic polymer can be swelled in an appropriate solvent for analysis.

In some embodiments, the first (meth)acrylate copolymer and the second (meth)acrylate copolymer, when present, each independently has a T_{g} in a range from 2° C. and 100° C., between 2° C. and 80° C., between 2° C. and 60° C., between 2° C. and 50° C., between 2° C. and 45° C., between 5° C. and 45° C., between 5° C. and 40° C., between 5° C. and 35° C., or between 10° C. and 30° C. In some embodiments, the first (meth)acrylate copolymer and the second (meth)acrylate copolymer, when present, each independently has a T_{g} no greater than 100° C., no greater than 80° C., no greater than 60° C., no greater than 50° C., no greater than 45° C., or even no greater than 40° C.

In some embodiments, the adhesive film has a thickness of at least 0.3 millimeter. In some embodiments, the adhesive film has a thickness in a range from 300 to 6000 micrometers, from 300 to 4000 micrometers, from 300 to 2000 micrometers, from 500 to 2000 micrometers, from 800 to 1500 micrometers, or from 600 to 1300 micrometers.

In some embodiments, the adhesive film of the present disclosure has a shear storage modulus of at least or more than 0.5 megapascals (MPa) as measured on a rheometer at 25° C. applying an oscillatory strain at 1 hertz (Hz) within the linear viscoelastic region of the adhesive film. In some embodiments, the adhesive film of the present disclosure has a storage modulus of at least 1 or 1.5 MPa. In some embodiments, the adhesive film of the present disclosure has a storage modulus of up to 4, 3.5, 3, 2.5, or 2 MPa. The storage modulus of the bulk adhesive film can conveniently be measured as described in the Examples, below. In embodiments in which the adhesive film is a multilayer film, as described in greater detail below, the storage modulus can be determined by atomic force microscopy (AFM)-based nanoindentation at a frequency and temperature in the rheologically relevant regime (0.1 Hz to 100 Hz).

The adhesive film of the present disclosure comprises not more than 5, 4, 3, 2, or 1 percent by weight of a further (meth)acrylate copolymer having from 0.1 weight percent to 15 weight percent (in some embodiments, 0.1 to 12 wt %, 0.1 to 11 wt %, from 0.1 to 10 wt %, from 0.2 to 10 wt %, from 0.2 to 9 wt %, from 0.2 to 8 wt %, from 0.3 to 8 wt %, from 0.5 to 8 wt %, from 0.5 to 6 wt %, from 1 to 6 wt %, or even from 1 to 5 wt %) of (meth)acrylic acid monomer units, based on the weight of the further (meth)acrylate copolymer. Such a further (meth)acrylate copolymer in the adhesive film of the present disclosure would tend to lower the T_{g} and/or the storage modulus of the adhesive film and would also tend to lower the cohesive strength of the adhesive film. In some embodiments, the adhesive film of the present disclosure is free of a further (meth)acrylate copolymer having from 0.1 weight percent to 15 weight percent (in some embodiments, 0.1 to 12 wt %, 0.1 to 11 wt %, from 0.1 to 10 wt %, from 0.2 to 10 wt %, from 0.2 to 9 wt %, from 0.2 to 8 wt %, from 0.3 to 8 wt %, from 0.5 to 8 wt %, from 0.5 to 6 wt %, from 1 to 6 wt %, or even from 1 to 5 wt %) of (meth)acrylic acid monomer units, based on the weight of the further (meth)acrylate copolymer.

The first (meth)acrylate copolymer for use herein may be prepared by any conventional free radical polymerization method, including solution, radiation, bulk, dispersion, emulsion, solventless, and suspension processes. The resulting copolymers may be random or block copolymers. In some embodiments, the first (meth)acrylate copolymer is prepared as either a solution or syrup copolymer composition.

A typical solution polymerization method is carried out by adding the monomers, a suitable solvent, and an optional chain transfer agent to a reaction vessel, adding a free radical initiator, purging with nitrogen, and maintaining the reaction vessel at an elevated temperature, typically in the range of about 40 to 100° C. until the reaction is completed, typically in about 1 to 24 hours, depending upon the batch size and temperature. Examples of the solvent are methanol, tetrahydrofuran, ethanol, isopropanol, tert-butanol, acetone, methyl ethyl ketone, methyl acetate, ethyl acetate, toluene, xylene, and an ethylene glycol alkyl ether. Those solvents can be used alone or as mixtures thereof.

A syrup polymer technique comprises partially polymerizing monomers to produce a syrup polymer comprising the first (meth)acrylate copolymer and unpolymerized monomers. The syrup polymer composition is polymerized to a useful coating viscosity, which may be coated onto a substrate (such as a tape backing) and further polymerized.

In some embodiments, the polymerization is conducted in the absence of a solvent such as ethyl acetate, toluene, or tetrahydrofuran which are unreactive with the functional groups of the components of the syrup polymer.

In some embodiments, a coatable syrup polymer is prepared by photoinitiated free radical polymerization. Polymerization to achieve a coatable viscosity may be conducted such that the conversion of monomers to polymer is up to about 10%. Polymerization can be terminated when the desired conversion and viscosity have been achieved by removing the light source and by bubbling air (oxygen) into the solution to quench propagating free radicals. Polymerization can be accomplished by exposing the syrup polymer composition to energy in the presence of a photoinitiator. Energy activated initiators may be unnecessary where, for example, ionizing radiation is used to initiate polymerization.

In some embodiments, the free radical photoinitiator is a type I (cleavage-type) photoinitiator. Cleavage-type photoinitiators include acetophenones, alpha-aminoalkylphenones, benzoin ethers, benzoyl oximes, acyl (e.g., benzoyl) phosphine oxides, acyl (e.g., benzoyl) phosphinates, and mixtures thereof. Examples of useful benzoin ethers include benzoin methyl ether and benzoin butyl ether. Examples of suitable acetophenone compounds include 4-diethylaminoacetophenone, 1-hydroxycyclohexyl phenyl ketone, 2-benzyl-2 dimethylamino-4′-morpholinobutyrophenone, 2-hydroxy-2-methyl-1-phenylpropan-1 one, 2,2-dimethoxyacetophenone, and 2,2-dimethoxy-1,2-diphenylethan-1-one. Example of suitable acyl phosphine oxide, acyl phosphinate, and acyl phosphonate compounds include bis(2,6-dimethoxybenzoyl)-2,4,4-trimethylpentyl phosphine oxide, phenylbis(2,4,6-trimethylbenzoyl) phosphine oxide, ethyl phenyl(2,4,6-trimethylbenzoyl)phosphinate, (2,4,6-trimethylbenzoyl)diphenylphosphine oxide, dimethyl pivaloylphosphonate, and poly(oxy-1,2-ethanediyl), α,α′,α″-1,2,3-propanetriyltris[ω-[[phenyl(2,4,6-trimethylbenzoyl)phosphinyl]oxy]. Further suitable photoinitiators include substituted α-ketols such as 2-methyl-2-hydroxy propiophenone; aromatic sulfonyl chlorides such as 2-naphthalene-sulfonyl chloride; and photoactive oximes such as 1-phenyl-1,2-propanedione-2-(O-ethoxy-carbonyl)oxime. Many photoinitiators are available, for example, from BASF, Vandalia, Ill. under the trade designation “IRGACURE”, from IGM Resins, Waalwijk, Netherlands, under the trade designations “OMNIRAD” and “ESACURE”. Two or more of any of these photoinitiators may also be used together in any combination. Additional photoinitiator can be added to a mixture to be coated after the copolymer has been formed, (i.e., photoinitiator can be added to the syrup polymer mixture).

The degree of conversion (of monomers to copolymer) can be monitored during the irradiation by measuring the index of refraction of the polymerizing mixture.

In some embodiments of the adhesive film of the present disclosure, the adhesive film comprises from 65 to 99 wt %, from 70 to 95 wt %, from 75 to 95 wt %, from 75 to 90 wt %, or even from 75 to 85 wt %, of the first (meth)acrylate copolymer, and wherein the weight percentages are based on the total weight of the adhesive film. In some embodiments, the adhesive film of the present disclosure comprises from 1 to 35 wt %, from 1 to 30 wt %, from 2 to 25 wt %, from 3 to 25 wt %, from 3 to 20 wt %, from 4 to 20 wt %, or even from 4 to 15 wt %, of the second (meth)acrylate copolymer, and wherein the weight percentages are based on the total weight of the adhesive film.

The second (meth)acrylate copolymer for use herein may be prepared by any conventional free radical polymerization method, including solution, radiation, bulk, dispersion, emulsion, and suspension processes. The resulting adhesive copolymers may be random or block copolymers.

The second (meth)acrylate copolymer for use herein can be polymerized by techniques including, but not limited to, the conventional techniques of solvent polymerization, dispersion polymerization, and solventless bulk polymerization. The monomer mixture may comprise a polymerization initiator, especially a thermal initiator or a photoinitiator of a type and in an amount effective to polymerize the comonomers.

A typical solution polymerization method is carried out by adding the monomers, a suitable solvent, and an optional chain transfer agent to a reaction vessel, adding a free radical initiator, purging with nitrogen, and maintaining the reaction vessel at an elevated temperature, typically in the range of about 40 to 100° C. until the reaction is completed, typically in about 1 to 20 hours, depending upon the batch size and temperature. Examples of the solvent are methanol, tetrahydrofuran, ethanol, isopropanol, tert-butanol, acetone, methyl ethyl ketone, methyl acetate, ethyl acetate, toluene, xylene, and an ethylene glycol alkyl ether. Those solvents can be used alone or as mixtures thereof.

The second (meth)acrylate copolymer can be formed by photopolymerization using any of the methods and photoinitiators described above.

In a typical thermal polymerization method, a monomer mixture may be subjected to thermal energy in the presence of a thermal polymerization initiator (i.e., thermal initiators). Examples of suitable thermal initiators are those available under the trade designations “VAZO” from DuPont.

Solventless polymerization methods, such as the continuous free radical polymerization method described in U.S. Pat. Nos. 4,619,979 and 4,843,134 (Kotnour et al.); the essentially adiabatic polymerization methods using a batch reactor described in U.S. Pat. No. 5,637,646 (Ellis); and, the methods described for polymerizing packaged pre-adhesive compositions described in U.S. Pat. No. 5,804,610 (Hamer et al.) may also be utilized to prepare the second (meth)acrylate copolymer.

In some embodiments, the second (meth)acrylate copolymer for use in the adhesive film of the present disclosure is prepared using an essentially solventless free-radical polymerization method, in particular, an essentially solventless thermal free-radical polymerization method. In some embodiments, the second (meth)acrylate copolymer for use herein is prepared by an essentially adiabatic polymerization method. The degree of conversion (of monomers to copolymer) can be monitored during the polymerization by measuring the index of refraction of the polymerizing mixture.

In some embodiments, the second (meth)acrylate copolymer for use in the adhesive film of the present disclosure is obtained as a pre-polymer composition having a polymer conversion rate greater than 10%, greater than 15%, greater than 20%, greater than 25%, greater than 30%, greater than 35%, greater than 40%, or greater than 45%, in some embodiments, having a polymer conversion rate comprised between 10 and 60%, between 20 and 55%, between 30 and 50%, or even between 35 and 50%.

If desired, a chain transfer agent may be added to the monomer mixture of either of the first or the second (meth)acrylate copolymers to control the molecular weight of the copolymer. Examples of useful chain transfer agents include carbon tetrabromide, alcohols, mercaptans, and mixtures thereof. In some embodiments, the chain transfer agent comprises at least one of isooctylthioglycolate or carbon tetrabromide.

The adhesive film may comprise, as optional ingredients, tackifying resins, in particular hydrogenated hydrocarbon tackifiers. Examples of hydrogenated hydrocarbon tackifiers include C9 and C5 hydrogenated hydrocarbon tackifiers. Examples of C9 hydrogenated hydrocarbon tackifiers include those sold under the trade designation: “REGALITE S-5100”, “REGALITE R-7100”, “REGALITE R-9100”, “REGALITE R-1125”, “REGALITE S-7125”, “REGALITE S-1100”, “REGALITE R-1090”, “REGALREZ 6108”, “REGALREZ 1085”, “REGALREZ 1094”, “REGALREZ 1126”, “REGALREZ 1139”, and “REGALREZ 3103”, sold by Eastman Chemical Co., Middelburg, Netherlands; “PICCOTAC” and EASTOTAC” sold by Eastman Chemical Co.; “ARKON P-140”, “ARKON P-125”, “ARKON P-115”, “ARKON P-100”, “ARKON P-90”, “ARKON M-135”, “ARKON M-115”, “ARKON M-100”, and “ARKON M-90” sold by Arakawa Chemical Inc., Chicago, IL; and “ESCOREZ 5000 series” sold by Exxon Mobil Corp., Irving, TX. In some embodiments, the tackifier is a partially hydrogenated C9 hydrogenated tackifier, a fully hydrogenated C9 hydrogenated tackifier, or a combination thereof.

In some embodiments, the adhesive film according to the present disclosure is substantially free of tackifying resins, in particular free of hydrocarbon tackifying resins.

Other additives can be added to the adhesive film of the present disclosure, if desired. For example, leveling agents, ultraviolet light absorbers, hindered amine light stabilizers (HALS), oxygen inhibitors, wetting agents, rheology modifiers, defoamers, biocides, flame retardants, and dyes can be included. All of these additives and the use thereof are known to those skilled in the art and may be used as long as they do not deleteriously affect the adhesive properties.

In some advantageous aspects, the adhesive film of the present disclosure comprises a filler material, in particular, a particulate filler material. In some embodiments, the optional filler material for use herein is selected from the group of polymeric microspheres, glass bubbles, and any combinations thereof.

In some embodiments, the adhesive film of the present disclosure composition comprises
from 65 to 98 wt %, from 70 to 95 wt %, from 75 to 95 wt %, from 75 to 90 wt %, or from 75 to 85 wt %, of the first (meth)acrylate copolymer;
from 0 to 35 wt %, 1 to 35 wt %, from 1 to 30 wt %, from 2 to 25 wt %, from 3 to 25 wt %, from 3 to 20 wt %, from 4 to 20 wt %, or from 4 to 15 wt %, of the second (meth)acrylate copolymer; and
optionally, from 2 wt % to 15 wt %, from 2 wt % to 14 wt %, or from 2 wt % to 12 wt % of a filler material comprising at least one of polymeric microspheres and glass bubbles, wherein the weight percentages are based on the total weight of the adhesive film.

The adhesive film of the present disclosure may be prepared by simple blending of the first and the second (meth)acrylate copolymer components, optionally with the optional ingredients such as the filler material and the tackifying resin. The copolymers can be blended using several conventional methods, such as melt blending, solvent blending, or any suitable physical means.

Physical blending devices that provide dispersive mixing, distributive mixing, or a combination of dispersive and distributive mixing are useful in preparing homogenous blends. Both batch and continuous methods of physical blending can be used. Examples of batch methods include BRABENDER (using a BRABENDER PREP CENTER, available from C. W. Brabender Instruments, Inc.; South Hackensack, NJ) or BANBURY internal mixing and roll milling (using equipment available from FARREL COMPANY, Ansonia, CT). Examples of continuous methods include single screw extruding, twin screw extruding, disk extruding, reciprocating single screw extruding, and pin barrel single screw extruding. The continuous methods can include utilizing both distributive elements, such as cavity transfer elements (e.g., CTM, available from RAPRA Technology, Ltd., Shrewsbury, England) and pin mixing elements, static mixing elements and dispersive elements (e.g., MADDOCK mixing elements or SAXTON mixing elements as described in “Mixing in Single-Screw Extruders,” Mixing in Polymer Processing, edited by Chris Rauwendaal (Marcel Dekker Inc., New York (1991), pp. 129, 176-177, and 185-186).

According to an aspect of the present disclosure, the adhesive film may be prepared by incorporating the second (meth)acrylate copolymer into a curable precursor composition of the first (meth)acrylate copolymer comprising the linear or branched alkyl (meth)acrylate monomer, the (meth)acrylic acid monomer, the crosslinking monomer, optionally a polymerization initiator, and optionally a particulate filler material, thereby forming a curable precursor composition of the adhesive film. The first (meth)acrylate copolymer is then formed in a second step, and in-situ by polymerizing the linear or branched alkyl (meth)acrylate monomer, the (meth)acrylic acid monomer, the crosslinking monomer to form the first (meth)acrylate copolymer in the presence of the second (meth)acrylate copolymer. In some embodiments, the second (meth)acrylate copolymer is diluted into the curable precursor composition of the first (meth)acrylate copolymer and mixed by shaking. In some embodiments, polymerizing the linear or branched alkyl (meth)acrylate monomer, the (meth)acrylic acid monomer, the crosslinking monomer to form the first (meth)acrylate copolymer in the presence of the second (meth)acrylate copolymer is carried out with actinic radiation. In some embodiments of the process for manufacturing the film adhesive of the present disclosure, the second (meth)acrylate copolymer is obtained by free-radical polymerization, in particular by an essentially solventless polymerization method, more in particular by an essentially adiabatic polymerization reaction. In some embodiments, the second (meth)acrylate copolymer is obtained as a pre-polymer composition having a polymer conversion rate greater than 10%, greater than 15%, greater than 20%, greater than 25%, greater than 30%, greater than 35%, greater than 40%, greater than 45%, or in range from 10 to 60%, from 20 to 55%, from 30 to 50%, or from 35 to 50%.

In some embodiments, the adhesive film of the present disclosure takes the form of a foam. A foam comprises voids, which may be open or closed cells. In some embodiments, the voids are present in the foam in an amount of at least 5% by volume, from 10% to 55% by volume, from 10% to 45% by volume, from 15% to 45% by volume, or from 20% to 45% by volume. An adhesive film in the form of a foam typically has a density in a range from 0.45 g/cm³ to 1.5 g/cm³, from 0.45 g/cm³ to 1.10 g/cm³, from 0.50 g/cm³ to 0.95 g/cm³, from 0.60 g/cm³ to 0.95 g/cm³, or from 0.70 g/cm³ to 0.95 g/cm³.

In some embodiments, the adhesive film in the form of a foam has a thickness in a range from 100 to 6000 micrometers, from 200 to 4000 micrometers, from 500 to 2000 micrometers, or from 800 to 1500 micrometers. In some embodiments, the adhesive film in the form of a foam has a thickness of at least 300 micrometers. As will be apparent to those skilled in the art, in the light of the present description, the thickness of the foamed adhesive film will be dependent on the intended application.

The voids or cells in the foam can be created in any of the known manners described in the art and include the use of a gas or blowing agent and/or including hollow particles into the composition for the foam. For example, according to one method to create a foam described in U.S. Pat. No. 4,415,615 (Esmay et al.), an acrylic foam can be obtained by frothing a composition containing acrylate monomers and optional comonomers, coating the froth on a backing, and polymerizing the frothed composition. It is also possible to coat the unfrothed composition of the acrylate monomers and optional comonomers to the backing and to then simultaneously foam and polymerize that composition. Frothing of the composition may be accomplished by whipping a gas into the polymerizable composition optionally in the presence of a surfactant (e.g., hydrocarbon or fluorochemical surfactant) or surface-modified nanoparticles to stabilize the foam. Inert gasses such as nitrogen, argon, and carbon dioxide may be useful, particularly if the polymerization is photoinitiated.

In some embodiments, the adhesive film in the form of a foam incorporates hollow fillers, such as hollow polymeric particles, hollow glass microspheres, and hollow ceramic microspheres. Hollow polymeric microspheres include elastomeric particles available, for example, from Akzo Nobel, Amsterdam, The Netherlands, under the trade designation “EXPANCEL”. Examples of hollow ceramic microspheres include alumina/silica microspheres having particle sizes in the range of 5 to 300 microns and a specific gravity of 0.7 (“FILLITE”, Pluess-Stauffer International), aluminum silicate microspheres having a specific gravity of from about 0.45 to about 0.7 (“Z-LIGHT”), calcium carbonate-coated polyvinylidene copolymer microspheres having a specific gravity of 0.13 (“DUALITE 6001AE”, Pierce & Stevens Corp.), and glass bubbles marketed by 3M Company, Saint Paul, Minnesota, as “3M GLASS BUBBLES” in grades K1, K15, K₂O, K25, K37, K46, S15, S22, S32, S35, S38, S38HS, S38XHS, S42HS, S42XHS, S60, S60HS, iM30K, iM16K, XLD3000, XLD6000, and G-65, and any of the HGS series of “3M GLASS BUBBLES”. Foams that include hollow microspheres are referred to as syntactic foams. Foamed adhesives can also include a hydrocarbon elastomer as described in U.S. Pat. No. 5,024,880 (Vesley et al.).

According to another aspect, the present disclosure is directed to a multilayer adhesive assembly comprising an adhesive film as described above in the form of a first adhesive film layer, in some embodiments, a first adhesive foam layer, which further comprises a second adhesive layer adjacent to the first adhesive film layer.

Multilayer adhesive assemblies of this type, and in particular dual layer or skin-core-skin foam tape assemblies, are advantageous when compared to single-layer adhesives, in that adhesion (quick adhesion) can be adjusted by the formulation of the second adhesive layer (also commonly referred to as the skin layer), while other properties/requirements of the overall assembly such as application issues, deforming issues and energy distribution may be addressed by appropriate formulation of the first adhesive film layer (also commonly referred to as the core layer).

In some embodiments, the multilayer adhesive assembly as described herein is in the form of a skin/core multilayer adhesive assembly, wherein the first layer is an adhesive film of the present disclosure, in some embodiments, in the form of a foam, and is the core layer of the multilayer adhesive assembly, and the second adhesive layer is the skin layer of the multilayer adhesive assembly.

In some embodiments, the multilayer adhesive assembly as described herein is in the form of a multilayer adhesive assembly further comprising a third adhesive layer, thereby forming, for example, a three-layered multilayer adhesive assembly. In some embodiments, the third adhesive layer is adjacent to the first adhesive layer on the side of the first adhesive layer which is opposite to the side of the first adhesive layer adjacent to the second adhesive layer. In some embodiments, the first, second, and third adhesive layers are superimposed.

In some embodiments, the multilayer adhesive assembly is in the form of a skin/core/skin multilayer adhesive assembly, wherein the first adhesive layer is an adhesive film layer of the present disclosure in the form of a foam and is the core layer of the multilayer adhesive assembly, the second adhesive layer is the first skin layer of the multilayer adhesive assembly, and the third adhesive layer is the second skin layer of the multilayer adhesive assembly.

The second adhesive layer and/or the third adhesive layer may have any composition commonly known in the art. As such, the composition of these various layers for use in the multilayer adhesive assemblies of the present disclosure is not particularly limited.

In some embodiments, the second adhesive layer and/or the third adhesive layer comprise a polymer base material independently selected from the group consisting of polyacrylates, polyurethanes, polyolefins, polyamines, polyamides, polyesters, polyethers, polyisobutylene, polystyrenes, polyvinyls, polyvinylpyrrolidone, natural rubbers, synthetic rubbers, and any combinations, copolymers or mixtures thereof. In some embodiments, the second adhesive layer and/or the third adhesive layer comprise a polymer base material selected from the group consisting of polyacrylates, polyurethanes, and any combinations, copolymers or mixtures thereof. In some embodiment, the second adhesive layer and/or the third adhesive layer comprise a polymer base material selected from the group consisting of polyacrylates, and any combinations, copolymers or mixtures thereof.

In some embodiments, the second adhesive layer and the third adhesive layer independently comprise a polyacrylate polymer base material whose main monomer component comprises a linear or branched alkyl (meth)acrylate ester, in some embodiments a non-polar linear or branched alkyl (meth)acrylate ester having a linear or branched alkyl group comprising from 1 to 32, from 1 to 20, or even from 1 to 15 carbon atoms.

In some embodiments, the second adhesive layer and the third adhesive layer independently comprise a polyacrylate polymer whose main monomer component comprises a linear or branched alkyl (meth)acrylate ester selected from the group consisting of methyl (meth)acrylate, ethyl (meth)acrylate, n-propyl (meth)acrylate, isopropyl (meth)acrylate, n-butyl acrylate, isobutyl acrylate, tert-butyl (meth)acrylate, n-pentyl (meth)acrylate, iso-pentyl (meth)acrylate, n-hexyl (meth)acrylate, iso-hexyl (meth)acrylate, cyclohexyl (meth)acrylate, phenyl (meth)acrylate, octyl (meth)acrylate, iso-octyl (meth)acrylate, 2-octyl(meth)acrylate, 2-ethylhexyl (meth)acrylate, decyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, 2-propylheptyl (meth)acrylate, stearyl (meth)acrylate, isobornyl (meth)acrylate, benzyl (meth)acrylate, nonyl (meth)acrylate, isophoryl (meth)acrylate, and any combinations or mixtures thereof. In some embodiments, the linear or branched alkyl (meth)acrylate ester comprises at least one of iso-octyl (meth)acrylate, 2-ethylhexyl (meth)acrylate, 2-propylheptyl (meth)acrylate, butyl acrylate, or 2-octyl (meth)acrylate, and in some embodiments, comprises at least one of iso-octyl acrylate, 2-octyl (meth)acrylate, 2-ethylhexyl (meth)acrylate, or 2-propylheptyl (meth)acrylate.

In some embodiments of the multilayer adhesive assembly of the present disclosure, the second adhesive layer and/or the third adhesive layer have a (co)polymeric composition identical or similar to the composition described above for the adhesive film of the present disclosure.

In some embodiments of the multilayer adhesive assembly of the present disclosure, the second adhesive layer and/or the third adhesive layer comprise a polyacrylate base material further comprising polar monomer units. In some embodiments, the polar comonomer comprises at least one of acrylic acid, methacrylic acid, itaconic acid, hydroxyalkyl acrylates, nitrogen-containing acrylate monomers, in particular acrylamides and substituted acrylamides, acrylamines and substituted acrylamines, and any combinations or mixtures thereof.

In some embodiments of the multilayer adhesive assembly of the present disclosure, the second adhesive layer and/or the third adhesive layer comprise a polyacrylate base material further comprising high T_{g} monomer units. In some embodiments, the high T_{g} monomer units comprise at least one of isobornyl (meth)acrylate, cyclohexyl (meth)acrylate, isophoryl (meth)acrylate, cyclohexyl (meth)acrylate, in some embodiment, isobornyl (meth)acrylate.

According to some aspects of the multilayer adhesive assemblies of the present disclosure, the second adhesive layer and/or the third adhesive layer further comprises a tackifying resin, in particular a hydrocarbon tackifying resin. The tackifying resin can be any of those described above.

Advantageously, the tackifying resin is selected from the group consisting of C5-based hydrocarbon resins, C9-based hydrocarbon resins, C5/C9-based hydrocarbon resins, and any combinations or mixtures or hydrogenated versions thereof.

In some embodiments, of the multilayer adhesive assembly of the present disclosure, the polymerizable material used to produce the second adhesive layer and/or the third adhesive layer, comprises from 50 to 99.5 weight percent, or from 60 to 95 weight percent, of a linear or branched alkyl (meth)acrylate ester as first/main monomer, wherein the main monomer is preferably selected from the group consisting of iso-octyl (meth)acrylate, 2-ethylhexyl (meth)acrylate, 2-propylheptyl (meth)acrylate, butyl acrylate; optionally from 1.0 to 50 weight percent, from 3.0 to 40 weight percent, from 5.0 to 35 weight percent, or from 10 to 30 weight percent, of the second monomer having an ethylenically unsaturated group, in some embodiments, a high Tg monomer; optionally from 0.1 to 15 weight percent, from 0.5 to 15 weight percent, from 1.0 to 10 weight percent, from 2.0 to 8.0 weight percent, from 2.5 to 6.0 weight percent, or from 3.0 to 6.0 weight percent of a polar monomer, such a polar (meth)acrylate; and optionally a tackifying resin, wherein the weight percentages are based on the total weight of polymerizable material used to produce the second adhesive layer and/or the third adhesive layer.

According to an advantageous aspect of the multilayer adhesive assemblies of the present disclosure, the second adhesive layer and/or the third adhesive layer comprise a polymer base material which further comprises a chlorinated polyolefinic (co)polymer. The incorporation of chlorinated polyolefinic (co)polymers in the curable precursor of the second adhesive layer and/or the third adhesive layer can improve the stability upon heat bond ageing and heat/humidity bond ageing of the resulting adhesive layers, in particular on low surface energy (LSE) substrates.

Examples of suitable chlorinated polyolefinic (co)polymers for use herein include those sold under the trade designation: “CPO 343-1”, sold by Eastman Chemical Co.; “13-LP”, “15-LP”, “16-LP” and “17-LP” sold by Toyo Kasei Kogyo Co. Ltd; “HYPALON CP 827B”, “HYPALON CP 163” and “HYPALON CP 183” sold by DuPont Co.; and “TYRIN CPE 4211P”, “TYRIN CPE 6323A” and “TYRIN CPE 3615P” sold by Dow Chemical Co. Suitable chlorinated polyolefins include chlorinated polypropylene, chlorinated polyethylene, chlorinated ethylene/vinyl acetate copolymer, and any combinations, mixtures or copolymers thereof. In some embodiments, the chlorinated polyolefinic (co)polymer is a chlorinated polypropylene.

In some embodiments, the multilayer adhesive assemblies as described above in any of their embodiments are obtained by a wet-on-wet coating process step. Exemplary “wet-in-wet” production processes for use herein are described in e.g., WO-A1-2011094385 (Hitschmann et al.) or in EP-Al-0259094 (Zimmerman et al.). In some embodiments, the method for manufacturing a multilayer adhesive assembly comprises a wet-on-wet coating process step.

According to another aspect, the present disclosure a process for manufacturing a multilayer adhesive assembly as described above in any of its embodiments, wherein the process comprises superimposing the (liquid) precursor of the first adhesive polymeric layer, the (liquid) precursor of the second adhesive layer, and optionally the (liquid) precursor of the third adhesive layer, thereby forming a curable precursor of the multilayer adhesive assembly and curing the curable precursor of the multilayer adhesive assembly, in some embodiments, with actinic radiation.

In some embodiments of the process for manufacturing a multilayer adhesive assembly, a (lower) layer of a curable (liquid) precursor of the second adhesive layer is covered by an adjacent (upper) layer of a curable liquid precursor of the first adhesive layer, respectively, essentially without exposing the (lower) layer of a curable (liquid) precursor of the second adhesive layer.

In some embodiments of the process for manufacturing a multilayer adhesive assembly, the process is a continuous and self-metered process for manufacturing a multilayer adhesive assembly. In some of these embodiments, the process comprises:
providing two or more coating knives which are offset, independently from each other, from the substrate to form a gap normal to the surface of the substrate;
moving the substrate relative to the coating knives in a downstream direction;
providing a curable (liquid) precursor of the first adhesive layer, a curable (liquid) precursor of the second adhesive layer, optionally a curable (liquid) precursor of the third adhesive layer, to the upstream side of the coating knives thereby coating the two or more curable liquid precursors through the respective gaps as superimposed layers onto the substrate. Practicing the continuous and self-metered method for manufacturing a multilayer adhesive assembly as above-described is well within the capabilities of the person skilled in the art, in the light of the present disclosure together with the disclosure of WO-A1-2011094385 (Hitschmann et al.). In particular, suitable settings and configurations for the coating apparatus, coating knives and coating stations, for use in this particular aspect of the method for manufacturing a multilayer adhesive assembly, will be easily identified by those skilled in the art, in the light of the present disclosure together with the disclosure of WO-A1-2011094385 (Hitschmann et al.).

In some embodiments of the process for manufacturing a multilayer adhesive assembly, the first adhesive polymeric layer, the second adhesive layer, and optionally the third adhesive layer, are prepared separately and subsequently laminated to each other. In other embodiments of the process for manufacturing a multilayer adhesive assembly, the process comprises a (co)extrusion processing step. In other embodiments of the process for manufacturing a multilayer adhesive assembly, the process is as described in U.S. Pat. No. 4,818,610 (Zimmerman et al.). The adhesive tapes of U.S. Pat. No. 4,818,610 (Zimmerman et al.) are prepared by sequentially coating liquid compositions each comprising at least one photopolymerizable monomer, onto a substrate. A liner can be attached to the top layer and the plurality of superimposed layers is cured by subjecting it to irradiation in order to provide the adhesive tape.

The adhesive film can conveniently be coated on a liner or between liners, which may be treated with a release coating, Any suitable material for the liner(s) and release coating nav be used. In some embodiments, the adhesive film can be coated on a liner having different release properties on each surface and optionally wound in a roll.

The adhesive films (in some embodiments, foams) and multilayer assemblies of the present disclosure can be applied to a variety of substrates. The substrates can be flexible or inflexible and be formed of a polymeric material, glass or ceramic material, metal, or combinations thereof. Suitable polymeric substrates include polymeric films such as those prepared from polypropylene, polyethylene, polyvinyl chloride, polyester (polyethylene terephthalate or polyethylene naphthalate), polycarbonate, polymethyl(meth)acrylate (PMMA), cellulose acetate, cellulose triacetate, and ethyl cellulose. Foam substrates may be used. Examples of other substrates include metals such as stainless steel, metal or metal oxide coated polymeric material, and metal or metal oxide coated glass.

As described above, in the presence of a primer, the adhesive film of the present disclosure functions as a PSA. The present disclosure provides an adhesive system comprising a primer composition and the adhesive film as described above in any of its embodiments. The adhesive film generally adheres to a primed substrate surface when applied without the use of heat or radiation. The adhesive film generally adheres to a primed substrate surface without the formation of covalent bonds. For example, the adhesive film generally does not react with the primer composition to form covalent bonds. The adhesive system may be useful, for example, for bonding a substrate. A method of bonding a substrate can include applying the primer composition to the substrate and then applying the adhesive film to the substrate. The primer composition may be allowed to stand on the substrate for at least 5, 10, 15, 30, or 60 minutes before the adhesive film is applied.

In some embodiments of the adhesive system and related methods, the primer composition comprises at least one of a polyamide, a polyurethane, or a polyacrylate. Polyurethane primers may undergo moisture curing after they are applied to the substrate but do not necessarily react with the adhesive film when it is applied to the primer. Other primer compositions are not reactive upon application and not reactive with the adhesive film. Suitable polyamide primers include those obtained from 3M Company under the trade designation “3M PRIMER 4297”. Suitable polyurethane primers include those obtain from 3M Company under the trade designation “3M PRIMER P591”, from Henkel under the trade designations “TEROSON 8519” and “TEROSON 8517”, and from Sika under the trade designation “SIKA 210”. Suitable polyacrylate primers include those obtained from 3M under the trade designation “3M PRIMER 9348” and from Tesa under the trade designation “TESA 60153”. In some embodiments, the surface DMT modulus is at least 0.5, 0.75, 0.8, 1, or at least 1.5 GPa as determined by AFM using the techniques described above.

The adhesive film and multilayer adhesive assembly of the present disclosure may be used in any article conventionally known to use such assemblies such as labels, tapes, signs, covers, marking indices, display components, and touch panels.

The adhesive film and multilayer adhesive assembly of the present disclosure may be coated/applied on a substrate using any conventional coating techniques modified as appropriate to the particular substrate. For example, the adhesive film may be applied/coated to a variety of solid substrates by methods such as roller coating, flow coating, dip coating, spin coating, spray coating knife coating, and die coating. These various methods of coating allow the adhesive compositions and assemblies to be placed on the substrate at variable thicknesses thus allowing a wider range of use of the assemblies.

The adhesive film and multilayer adhesive assembly of the present disclosure may be useful for forming strong adhesive bonds to low surface energy (LSE) substrates. Included among such materials are polypropylene, polyethylene (e.g., high density polyethylene or HDPE), blends of polypropylene (e.g., PP/EPDM, TPO), or even some clear coat surfaces. Other substrates may also have properties of low surface energy due to a residue, such as an oil residue or a film, such as paint, being on the surface of the substrate.

The adhesive film and multilayer adhesive assembly of the present disclosure may also be useful for bonding to medium surface energy (MSE) substrates such as, for example, polyamide 6 (PA6), acrylonitrile butadiene styrene (ABS), polycarbonate (PC)/ABS blends, PC, PVC, polyurethane (PUR), thermoplastic elastomers (TPE), polyoxymethylene (POM) polystyrene, poly(methyl methacrylate) (PMMA), some clear coat surfaces, in particular clear coats for vehicles like a car or coated surfaces for industrial applications and composite materials like fiber reinforced plastics.

The adhesive film and multilayer adhesive assembly of the present disclosure may also be useful for bonding higher surface energy (HSE) substrates such as, for example, ceramics, glasses, and metals.

Accordingly, the present disclosure is further directed to the use of adhesive compositions and assemblies as above described for the bonding to a low surface energy substrate, a medium surface energy substrate and/or a high surface energy substrate.

In some embodiments, the adhesive film and multilayer adhesive assembly of the present disclosure has a static shear strength value to aluminum of more than 2000 min, more than 4000 min, more than 6000 min, more than 8000 min, or even more than 10000 min, when measured at 110° C. according to the static shear test method described in the experimental section.

The substrate to which the adhesive film and multilayer adhesive assembly of the present disclosure may be applied is selected depending on the particular application. For example, the multilayer adhesive assembly, in particular via its second and/or third adhesive layer may be applied to sheeting products (e.g., decorative graphics and reflective products), label stock, and tape backings.

Additionally, the adhesive film and multilayer adhesive assembly of the present disclosure may be applied directly onto other substrates such as a metal panel (e.g., automotive panel) or a glass window so that yet another substrate or object can be attached to the panel or window. Accordingly, the adhesive film and multilayer adhesive assembly of the present disclosure may find a particular use in the automotive manufacturing industry (e.g., for attachment of exterior trim parts or for weatherstrips), in the construction industry or in the solar panel construction industry.

Accordingly, the present disclosure is further directed to the use of adhesive films and assemblies as above described for industrial applications, in particular for construction applications, automotive applications (e.g., including specialty vehicles such as trucks, trains, and buses), appliances, cladding, and displays.

As described above, the adhesive film generally adheres to a primed substrate surface when applied without the use of heat or radiation. The adhesive film generally adheres to a primed substrate surface without the formation of covalent bonds. Advantageously, no crosslinking agent or reactive chemistry is necessary in the adhesive film in order to build up adhesive strength. Thus, the adhesive film generally does not include a thermal crosslinking additive such as a multifunctional aziridine, isocyanate, or epoxy or chemical crosslinkers such as peroxides. Also, the adhesive film generally does not include a photochemical crosslinking additive to be activated after it is applied to the substrate. In some embodiments, the adhesive film of the present disclosure does not include multifunctional aziridines, multifunctional isocyanates, multifunctional epoxides, benzophenone, triazines, multifunctional carboxylates, oxetanes, or oxazolines.

As shown in the Examples, below, the adhesive system of the present disclosure can provide overlap shear adhesion strength on aluminum of at least 2 MPa or at least 2.5 MPa. In contrast, when a comparative adhesive film includes a further (meth)acrylate copolymer having from 0.1 weight percent to 15 weight percent (in some embodiments, 0.1 to 11 wt %, from 0.1 to 10 wt %, from 0.2 to 10 wt %, from 0.2 to 9 wt %, from 0.2 to 8 wt %, from 0.3 to 8 wt %, from 0.5 to 8 wt %, from 0.5 to 6 wt %, from 1 to 6 wt %, or even from 1 to 5 wt %) of (meth)acrylic acid monomer units, based on the weight of the further (meth)acrylate copolymer, for example, as the major component of the adhesive film, the overlap shear adhesion strength on aluminum is generally not more than 1.5 MPa.

Item 1 is an adhesive film comprising:
a first (meth)acrylate copolymer comprising:
   at least 55 weight percent of linear or branched alkyl (meth)acrylate monomer units, based on the weight of the first (meth)acrylate copolymer;
   from 15 weight percent to 40 weight percent of (meth)acrylic acid monomer units, based on the weight of the first (meth)acrylate copolymer, wherein if the first (meth)acrylate copolymer comprises 15 weight percent (meth)acrylic acid monomer units, the first (meth)acrylate copolymer comprises at least five weight percent monomer units of a high T_{g} monomer that when homopolymerized provides a homopolymer having a glass transition temperature of at least 50° C., based on the weight of the first (meth)acrylate copolymer; and
   0.1 weight percent to 5 weight percent of monomer units of a crosslinking monomer having more than one (meth)acrylate group, based on the weight of the first (meth)acrylate copolymer,
wherein the adhesive film comprises not more than five percent by weight of a further (meth)acrylate copolymer comprising from 0.1 weight percent to 15 weight percent of (meth)acrylic acid monomer units, based on the weight of the further (meth)acrylate copolymer.

Item 2 is the adhesive film of item 1, wherein the first (meth)acrylate copolymer comprises (meth)acrylic acid monomer units in an amount greater than 15 weight percent (wt %), at least 15.5 wt %, at least 16 wt %, or at least 17 wt %, based on the weight of the first (meth)acrylate copolymer.

Item 3 is the adhesive film of item 1 or 2, wherein the first (meth)acrylate copolymer comprises from 15.5 wt % to 40 wt %, 16 wt % to 40 wt %, from 16 wt % to 35 wt %, from 16 wt % to 30 wt %, from 16 wt % to 25 wt %, from 17 wt % to 25 wt %, from 17 wt % to 23 wt %, or from 17 wt % to 20 wt % of (meth)acrylic acid monomer units, based on the weight of the first (meth)acrylate copolymer.

Item 4 is the adhesive film of item 2 or 3, further comprising monomer units of a high T_{g} monomer that when homopolymerized provides a homopolymer having a glass transition temperature of at least 50° C.

Item 5 is the adhesive film of any one of items 1 to 4, wherein the adhesive film has a storage modulus of at least or more than 0.5 megapascals as measured on a rheometer at 25° C. and 1 hertz.

Item 6 is the adhesive film of any one of items 1 to 5, wherein the first (meth)acrylate copolymer has a T_{g} in a range from 2° C. to 100° C., from 2° C. to 80° C., from 2° C. to 60° C., from 2° C. to 50° C., from 2° C. to 45° C., from 5° C. to 45° C., from 5° C. to 40° C., from 5° C. to 35° C., or from 10° C. to 30° C.

Item 7 is the adhesive film of any one of items 1 to 6, having a thickness of at least 0.3 millimeters and optionally up to 6, 4, or 2 millimeters.

Item 8 is the adhesive film of any one of items 1 to 7, wherein the linear or branched alkyl (meth)acrylate monomer units comprise linear or branched C₁-C₃₂(meth)acrylate monomer units, C₁-C₂₄ (meth)acrylate monomer units, or C₁-C₁₈(meth)acrylate monomer units.

Item 9 is the adhesive film of any one of items 1 to 8, wherein the linear or branched alkyl (meth)acrylate monomer units comprise at least one of 2-ethylhexyl (meth)acrylate, 2-propylheptyl (meth)acrylate, or iso-octyl (meth)acrylate.

Item 10 is the adhesive film of any one of items 1 to 9, wherein the adhesive film is a foam.

Item 11 is the adhesive film of item 10, comprising from two weight percent to 30 weight percent of at least one of polymeric expandable microspheres or glass bubbles, based on the total weight of the adhesive film.

Item 12 is the adhesive film of any one of items 1 to 11, further comprising a second (meth)acrylate copolymer comprising from greater than 15 weight percent to 40 weight percent of (meth)acrylic acid monomer units, based on the weight of the second (meth)acrylate copolymer.

Item 13 is the adhesive film of item 12, which comprises from 65 wt % to 99 wt %, from 70 wt % to 95 wt %, from 75 wt % to 95 wt %, from 75 wt % to 90 wt %, or from 75 wt % to 85 wt %, of the first (meth)acrylate copolymer and from 1 wt % to 35 wt %, from 1 wt % to 30 wt %, from 2 wt % to 25 wt %, from 3 wt % to 25 wt %, from 3 wt % to 20 wt %, from 4 wt % to 20 wt %, or from 4 wt % to 15 wt %, of the second (meth)acrylate copolymer, based on the total weight of the adhesive film.

Item 14 is the adhesive film of item 12 or 13, wherein at least one of the first (meth)acrylate copolymer or the second (meth)acrylate copolymer comprises from 15.5 wt % to 40 wt %, 16 wt % to 40 wt %, from 16 wt % to 35 wt %, from 16 wt % to 30 wt %, from 16 wt % to 25 wt %, from 17 wt % to 25 wt %, from 17 wt % to 23 wt %, or from 17 wt % to 20 wt % of (meth)acrylic acid monomer units, based on the weight of the first or second (meth)acrylate copolymer and from 60 wt % to 84.5 wt %, from 65 to 84 wt %, or from 77 to 83 wt %, of linear or branched C₁-C₃₂ (meth)acrylate monomer units, C₁-C₂₄ (meth)acrylate monomer units, or C₁-C₁₈ (meth)acrylate monomer units, based on the weight of the first or second (meth)acrylate copolymer.

Item 15 is the adhesive film of any one of items 12 to 14, which comprises:
from 65 wt % to 99 wt %, from 70 wt % to 95 wt %, from 75 wt % to 95 wt %, from 75 wt % to 90 wt %, or even from 75 wt % to 85 wt %, of the first (meth)acrylate copolymer;
from 1 wt % to 35 wt %, from 1 wt % to 30 wt %, from 2 wt % to 25 wt %, from 3 wt % to 25 wt %, from 3 wt % to 20 wt %, from 4 wt % to 20 wt %, or from 4 wt % to 15 wt %, of the second (meth)acrylate copolymer; and
optionally, from 2 wt % to 30 wt %, from 2 wt % to 20 wt %, or from 2 wt % to 15 wt % of a filler material comprising at least one of expandable microspheres or glass bubbles; based on the total weight of the adhesive film.

Item 16 is the adhesive film of any one of items 1 to 15, which is substantially free of tackifying resins, in particular, free of hydrocarbon tackifying resins.

Item 17 is the adhesive film of any one of items 1 to 16, wherein the adhesive film is a multilayer adhesive assembly comprising a first layer comprising the first (meth)acrylate copolymer and a second adhesive layer adjacent to the first layer.

Item 18 is the adhesive film of item 17, which is in the form of a skin/core multilayer adhesive assembly, wherein the first layer comprising the first (meth)acrylate copolymer is the core layer of the multilayer adhesive assembly and the second adhesive layer is the skin layer of the multilayer adhesive assembly.

Item 19 is the adhesive film of item 17 or 18, which is in the form of a multilayer adhesive assembly further comprising a third adhesive layer which is adjacent to the first adhesive layer on the side of the first adhesive layer which is opposite to the side of the first adhesive layer adjacent to the second adhesive layer.

Item 20 is the adhesive film item 19, which is in the form of a skin/core/skin multilayer adhesive assembly, wherein the first adhesive layer is the core layer of the multilayer adhesive assembly, the second adhesive layer is the first skin layer of the multilayer adhesive assembly and the third adhesive layer is the second skin layer of the multilayer adhesive assembly.

Item 21 is the adhesive film of any one of items 17 to 20, wherein the second adhesive layer and/or the third adhesive layer comprises a polymer base material selected from the group consisting of polyacrylates, polyurethanes, polyolefins, polyamines, polyamides, polyesters, polyethers, polyisobutylene, polystyrenes, polyvinyls, polyvinylpyrrolidone, natural rubbers, synthetic rubbers, and any combinations, copolymers or mixtures thereof.

Item 22 is the adhesive film of any one of items 17 to 21, wherein the second adhesive layer and/or the third adhesive layer comprises a polyacrylate polymer comprising linear or branched alkyl (meth)acrylate units having a linear or branched alkyl group having from 1 to 32, from 1 to 20, or from 1 to 15 carbon atoms.

Item 23 is the adhesive film of item 22, wherein the linear or branched alkyl (meth)acrylate units comprise at least one of isooctyl (meth)acrylate, 2-ethylhexyl (meth)acrylate, 2-propylheptyl (meth)acrylate, 2-octyl (meth)acrylate, or butyl acrylate units.

Item 24 is the adhesive film of item 22 or 23, wherein the polyacrylate polymer further comprises polar monomer units comprising monomer units of at least one of acrylic acid, methacrylic acid, itaconic acid, hydroxyalkyl acrylates, nitrogen-containing acrylate monomers, in particular acrylamides and substituted acrylamides and acrylamines and substituted acrylamines and any combinations or mixtures thereof.

Item 25 is the adhesive film of any one of items 22 to 24, wherein the polyacrylate polymer further comprises monomer units of at least one of isobornyl (meth)acrylate, cyclohexyl (meth)acrylate, isophoryl (meth)acrylate, or cyclohexyl (meth)acrylate.

Item 26 is the adhesive film of any one of items 17 to 25, wherein the second adhesive layer and/or the third adhesive layer comprises a tackifying resin, in particular a hydrocarbon tackifying resin.

Item 27 is the adhesive film of item 26, wherein the tackifying resin comprises at least one of a C5-based hydrocarbon resin, a C9-based hydrocarbon resin, or a C5/C9-based hydrocarbon resin.

Item 28 is the adhesive film of any one of items 17 to 27, wherein the second adhesive layer and/or the third adhesive layer further comprises a chlorinated polyolefinic (co)polymer comprising at least one of a chlorinated polypropylene, a chlorinated polyethylene, or a chlorinated ethylene/vinyl acetate copolymer.

Item 29 is the adhesive film of any one of items 17 to 28, wherein the second adhesive layer and/or the third adhesive layer is independently an adhesive film of any one of items 1 to 16.

Item 30 is the adhesive film of any one of items 17 to 29, which is obtained by a wet-on-wet coating process step.

Item 31 is process for manufacturing the adhesive film of any one of items 12 to 16, the process comprising:
incorporating the second (meth)acrylate copolymer into a curable precursor composition comprising the linear or branched alkyl (meth)acrylate monomer, the (meth)acrylic acid monomer, the crosslinking monomer, and a polymerization initiator; and
polymerizing the linear or branched alkyl (meth)acrylate monomer, the (meth)acrylic acid monomer, the crosslinking monomer to form the (meth)acrylate copolymer in the presence of the second (meth)acrylate copolymer.

Item 32 is the process of item 31, wherein the second (meth)acrylate copolymer is obtained by free-radical polymerization, in particular by an essentially solventless polymerization method, more in particular by an essentially adiabatic polymerization reaction.

Item 33 is the process of item 31 or 32, wherein the second (meth)acrylate copolymer is obtained as a pre-polymer composition having a polymer conversion of at least 10%, at least 15%, at least 20%, at least 25%, at least 30%, at least 35%, at least 40%, at least 45%, in a range from 10% to 60%, from 20% to 55%, from 30% to 50%, or from % to 50%.

Item 34 is a process for manufacturing the adhesive film of any of items 17 to 30, the process comprising:
superimposing a (liquid) precursor of the first adhesive layer, a (liquid) precursor of the second adhesive layer, and optionally a (liquid) precursor of the third adhesive layer, thereby forming a curable precursor of the multilayer adhesive assembly; and
curing the curable precursor of the multilayer adhesive assembly.

Item 35 is the process of item 34, wherein curing the curable precursor is carried out with actinic radiation.

Item 36 is the process of item 34 or 35, wherein a (lower) layer of a curable (liquid) precursor of the second adhesive layer is covered by an adjacent (upper) layer of a curable liquid precursor of the first adhesive polymeric layer, respectively, essentially without exposing the (lower) layer of a curable (liquid) precursor of the second adhesive layer.

Item 37 is the process of item 36, which comprises a (co)extrusion processing step.

Item 38 is the process of item 37, wherein the first adhesive layer, the second adhesive layer, and optionally the third adhesive layer, are prepared separately and subsequently laminated to each other.

Item 39 is the adhesive film of any one of items 1 to 30, wherein the adhesive film adheres to a primed substrate surface when applied without the use of heat or radiation.

Item 40 is the adhesive film of any one of items 1 to 30 or 39, wherein the adhesive film adheres to a primed substrate surface without the formation of covalent bonds.

Item 41 is an adhesive system comprising a primer composition and the adhesive film of any one of any one of items 1 to 30, 39, and 40 wherein the adhesive film does not react with the primer composition to form covalent bonds.

Item 42 is the adhesive system of item 41, wherein the primer composition comprises at least one of a polyamide, a polyurethane, or a polyacrylate.

Item 43 is the use of or the method of using the adhesive system of item 41 or 42 for bonding a substrate.

Item 44 is the use or method of item 43, wherein the substrate is a low surface energy substrate, a medium surface energy substrate, and/or a high surface energy substrate.

Item 45 is the use or method of item 43 or 44, wherein the substrate is useful in the construction industry or automotive industry.

The present disclosure is further illustrated by the following examples. These examples are merely for illustrative purposes only and are not meant to be limiting on the scope of the appended claims.

### EXAMPLES

TABLE 1
Materials

| Designation | Description |
|---|---|
| EHA | 2-ethylhexyl acrylate, obtained under the trade designation |
| | “2-EHA”, from BASF AG, Frankfurt am Main, Germany |
| AA | Acrylic acid, obtained from BASF AG |
| “OMNIRAD 651” | 2,2-dimethoxy-1,2-diphenylethan-1-one, obtained under |
| | the trade designation “OMNIRAD 651”, from IGM, |
| | Waalwijk, Netherlands |
| MMA | Methyl methacrylate, obtained from Sigma |
| | Aldrich, Schnelldorf, Germany |
| DCPA | Dihydrodicyclopentadienylacrylate obtained under the trade |
| | designation “DCPA”, from BASF AG |
| HDDA | 1.6-Hexanediol diacrylate, obtained from Sigma Aldrich |
| IBOA | Isobornyl acrylate, obtained under the trade designation |
| | “SR 506”, from Sartomer, Villers-Saint-Paul, France |
| “GLASS | Hollow glass spheres K15, obtained under the trade designation |
| BUBBLES K15” | “GLASS BUBBLES K15”, from 3M Company. St. Paul, MN |
| “AEROSIL R972” | Fumed silica particles, obtained under the trade designation |
| | “AEROSIL R972” from Evonik, Esson, Germany |
| HTGO | HTGO is a high Tg acrylic oligomer having a Mw of 25,000 |
| | g/mol. used as 50 wt % dilution in 2-EHA) and prepared |
| | according to the procedure described in EP-A1-2803712 |
| | (Wieneke et al.) for the copolymer referred to as HTG-1d |
| “ARKON P125” | A fully hydrogenated hydrocarbon resin, obtained under the |
| | trade designation “ARKON P125”, from Arakawa Chemical |
| | Inc., Chicago, IL |
| “REGALITE S7125” | A partly hydrogenated hdrycarbon resin, obtained under the trade |
| | designation “REGALITE S7125”, from Eastman Chemical THF |
| | GmbH, CologneGermany |
| “3M PRIMER 4297” | A primer for pressure sensitive adhesives, obtained under the |
| | trade designation “3M PRIMER 4297”, from 3M Company, |
| | St. Paul. MN |
| “VHB 4936” | A VHB Tape, obtained under the trade designation “VHB 4936”, |
| | from 3M Company, St. Paul. MN |
| “VAZO 52” | 2,2 azobis (2,4 dimethylpentanenitrile) Initiator, obtained under the |
| | trade designation “VAZO 52” from Dupont, Hoechst, Germany |

### Test Methods:

### Test Substrates Used for Testing:

Stainless Steel (SS) plates (“Edelstahl 1.4301 IIID”, 150 mm×50 mm×2 mm), were obtained from Rocholl GmbH, Eschenbronn, Germany.

Aluminum (Al) substrates (1 inch by 2 inches by 0.064 inch (2.5 cm by 5 cm by 1.1 mm)) were obtained from Rocholl GmbH, Eschenbronn, Germany.

Prior to testing, the substrates were cleaned as follows: The Al and SS plates were first cleaned with MEK and n-heptane, dried with a tissue, and then cleaned with MEK and dried with a tissue.

90°-Peel-Test at 300 mm/min (According to Test Method, Finat No. 2):

Adhesive films according to the present disclosure and having a width of 10 mm and a length>175 mm were cut out in the machine direction from the sample material.

For test sample preparation, the liner was first removed from the one adhesive side and placed on an aluminum strip having the following dimension 22×1.6 cm. Then, the adhesive coated side of each PSA strip was placed after the liner was removed, with its adhesive side down on a primed stainless steel test panel (primed with “3M PRIMER 4297”) using light finger pressure. Next, the test samples were rolled twice in each direction with a standard FINAT test roller (weight 6.8 kg) at a speed of approximately 10 mm per second to obtain intimate contact between the adhesive mass and the surface. After applying the adhesive compositions and assemblies strips to the test panel, the test samples were allowed to dwell 24 or 72 hours at ambient room temperature (23° C.+/−2° C. 50% relative humidity+/−5%° C.) prior to testing.

For peel testing, the test samples were in a first step clamped in the lower movable jaw of a Zwick tensile tester (Model Z020 commercially available from Zwick/Roell GmbH, Ulm, Germany). The pressure sensitive adhesive film strips were folded back at an angle of 90° and their free ends grasped in the upper jaw of the tensile tester in a configuration commonly utilized for 90° peel measurements. The tensile tester was set at 300 mm per minute jaw separation rate. Test results were expressed in Newton per 10 mm (N/10 mm). The recorded peel values were the average of two 90°-peel measurements.

Static Shear Test at 110° C. with 1000 g (FINAT TestMethod No. 8. 8th edition 2009) The static shear was a measure of the cohesiveness or internal strength of an adhesive. It was measured in units of time (minutes) required to pull a standard area of adhesive film from a test panel under stress of a constant, standard load.

A strip of 25 mm wide and 12.7 mm long was cut in machine direction from adhesive film. One release liner was removed from the strip and the PSA sample was attached through its exposed adhesive surface onto an anodized aluminum backing. Then, the second release liner was removed and the PSA sample was attached to the test substrate which was coated with “3M PRIMER 4297”, providing a bond area of 25 mm×12.7 mm and using light finger pressure. The standard FINAT test roller (6.8 kg) was rolled one time in each direction at a speed of approximately 10 mm per second to obtain intimate contact between the adhesive mass and the substrate surface. After applying the PSA strip to the test plate, the test plate was left at room temperature for a period of 24 hours before testing. A loop was prepared at the end of the test strip in order to hold the specified weight. The test panel was placed in a shear holding device. After a 15-minute dwell time at the test temperature of 110° C., the 1000 g load was attached in the loop. The timer was started. The results were recorded in minutes and are the average of three shear measurements. A recorded time of “10000+” indicated that the adhesive did not fail after 10000 min.

### Single Lap Shear Test (Overlap Shear Test) Based on ASTMD 1002 DIN EN 1465

The overlap shear (OLS) was used to measure the cohesiveness or internal strength of an adhesive film. Aluminum substrates, described above, were washed with MEK, then grid sandblasted and cleaned with MEK, followed by air-drying for ten minutes. The substrates were then primed with “3M PRIMER 4297” primer. Priming was done by a wool dauber supplied by 3M Company so that about two inches was coated. Primed substrates were allowed to air dry a minimum of ten minutes before adhesive application. Specimens were made by cutting a 1-inch (2 cm) strip of adhesive. One liner was removed and adhesive laid across the primed portion of the substrate. A 2-inch (5.1 cm) firm rubber roller was used to insure full contact of the adhesive. Bonds were formed by removing the top release liner exposing the adhesive and introducing it to a second primed substrate. Closed bonds were then subjected to applied pressure of about 150 N for 30 seconds and the bonded test assembly was dwelled at room temperature (23° C.+/−2° C. 50% relative humidity+/−5%° C.) for 3 days prior to testing. A dynamic overlap shear test was performed at 23° C. using a Zwick tensile tester (Model Z020 commercially available from Zwick/Roell GmbH, Ulm, Germany). Test specimens were loaded into the grips and the crosshead was operated at 1 inch (2.5 mm) per minute, loading the specimen to failure. Stress at break was recorded in units of MPa using testing methods disclosed in ASTM D1002. The results are reported in Tables 4 and 5, below. The failure mode for each Example and Comparative Example was Cohesive Failure.

### Shear Storage Modulus

A strain-controlled rheometer in oscillatory shear mode at a constant frequency of 1 Hz equipped with a parallel plate geometry (8 mm) was used (Model ARES G2 available from TA Instruments, 159 Lukens Drive, New Castle, DE 19720, USA). Circular die-cut samples of 8 mm diameter and 0.6 mm thickness were exposed to a temperature ramp from −50 to +150° C. applying a heating rate of 5° C./min. Oscillatory strain- and the normal force control were adjusted in a way, so that proper contact between sample and measurement geometry and deformation levels within the linear viscoelastic region of the sample material were maintained throughout the entire temperature range. The glass transition was determined as the peak temperature of the loss tangent. The complex modulus, the storage modulus, and the loss tangent were monitored throughout the entire temperature range and specifically determined at 25° C. For the comparison of tape formulations, the complex modulus was evaluated. The complex modulus was determined by the storage modulus reflecting the Dahlquist criterion and the respective loss tangent tan 6, which is the ratio of loss modulus and storage modulus.

### Preparation of Second Acrylate Copolymer:

A second (meth)acrylate copolymer, hereinafter referred to as Copolymer 2 was prepared as follows. The polymerization was carried out using a Buchi Polycave stainless steel reactor (Available from Buchi Labortechnik GmbH, City, The Netherlands). In the first step of the polymerization, the Buchi reactor was charged with 250 grams of a mixture of EHA (80 wt. %), AA (20 wt. %), IOTG (0.04 wt. %) and 3 ppm of “VAZO 52” initiator. The reactor was sealed and purged of oxygen and then held at approximately 1 bar nitrogen pressure. The reaction mixture was heated to 60° C. and the reaction proceeded adiabatically. The reaction peak temperature was 110° C. When the reaction was complete the mixture was cooled to below 50° C. The polymerization conversion was approximately around 35%.

### Precursors to Examples 1 to 6

Precursor compositions for Examples 1 to 6 were prepared by first diluting Copolymer 2 as described above in a polymerization precursor composition comprising the C8 acrylate (EHA) and the acrylic acid (between 15 wt. % and 20 wt. %) and other high Tg monomers as shown in Table 2, below. All the time, the resulting composition was mixed by shaking it with a rolling bench (Model LD 209, available from Labortechnik Frobel, Germany) propeller stirrer (150 U/min) for about 24 hours, and the mixing was stopped when a clear homogeneous mixture was obtained. Then, the photoinitiator OMNIRAD 651, the HDDA crosslinker, and the fumed silica particles were added and again mixed by shaking for about 24 hours. In a third step, the glass bubbles were added, and the mixture was stirred with a propeller stirrer (300 U/min) for 5 minutes until they were dispersed. The exact formulations of the polymerization precursor compositions for Examples 1 to 6 are listed in Table 2 below. The corresponding first (meth)acrylate copolymers were formed in-situ in presence of the second (meth)acrylate copolymer.

### Precursors of Example 7, Illustrative Example 8, Example FL-9, and Skin Layers 1 to 6

The precursors of the Examples 7 and FL-9, Illustrative Example 8, and Skin Layers 1 to 6 were prepared by combining the monomers composition comprising the C8 acrylate (2-EHA) and the acrylic acid and IBOA with 0.04 pph photoinitiator in a glass vessel. Before the UV exposure was initiated, the mixture was flushed 10 minutes with nitrogen, and nitrogen was bubbled into the mixture the whole time until the polymerization process was stopped by adding air to the syrup. All the time the mixture was stirred with a propeller stirrer (300 rotations per minute (U/min)) and the reaction was stopped when a viscosity of 2800-4000 mPas was reached, when measured with a Brookfield viscosimeter (Model DV1 Digital Viscosimeter, Hadamar-Steinbach, Germany), T=25° C. spindle 4. 12 rpm. Then the photoinitiator OMNIRAD 651, the HDDA crosslinker, DCPA, and the fumed silica particles were added and again mixed. In a third step, the glass bubbles were added, and the mixture was stirred with a propeller stirrer (300 U/min) for 5 minutes until they have dissolved/dispersed. The exact formulations of the polymerization precursor compositions are listed in Tables 2 and 3, below.

TABLE 2
Precursors of Examples 1 to 7 (EX-1 to
EX-7) and Illustrative Example 8 (IE-8)

| | EX-1 | EX-2 | EX-3 | EX-4 | EX-5 | EX-6 | EX-7 | IE-8 |
|---|---|---|---|---|---|---|---|---|
| 2-EHA (wt %) | 82.50 | 82.5 | 82.5 | 80.00 | 80.00 | 80.00 | 70.00 | 85.00 |
| AA (wt %) | 17.50 | 17.5 | 17.5 | 20.00 | 20.00 | 20.00 | 15.00 | 15.00 |
| DCPA (pph) | | | | 3.00 | | | | |
| MMA (pph) | | | | | 3.00 | | | |
| IBOA (wt %) | | | | | | | 15.00 | |
| HDDA (pph) | 0.20 | 0.20 | 0.5 | 0.12 | 0.12 | 0.12 | 0.2 | 0.2 |
| Copolymer 2 | 12.00 | 12.00 | 12.00 | 12.00 | 12.00 | 12.00 | — | — |
| (pph) | | | | | | | | |
| OMNIRAD | 0.16 | 0.16 | 0.16 | 0.16 | 0.16 | 0.16 | 0.16 | 0.16 |
| 651 (pph) | | | | | | | | |
| Aerosil | 2.00 | 2.00 | 2.00 | 2.00 | 2.00 | 2.00 | 2.00 | 2.00 |
| R972 (pph) | | | | | | | | |
| GB K15 (pph) | 3.00 | | 3.00 | 3.00 | 3.00 | 3.00 | 3.00 | 3.00 |

TABLE 3
Precursors of for Skin Layers SL-1-SL-6 and FL-9

| | SL-1 | SL-2 | SL-3 | SL-4 | SL-5 | SL- 6 | FL-9 |
|---|---|---|---|---|---|---|---|
| 2-EHA (wt %) | 90.00 | 87.50 | 87.50 | 85.00 | 82.50 | 82.50 | 82.50 |
| AA (wt %) | 10.00 | 12.50 | 12.50 | 15.00 | 17.50 | 17.50 | 17.50 |
| OMNIRAD 651 | 0.16 | 0.16 | 0.16 | 0.16 | 0.16 | 0.16 | 0.16 |
| (pph) | | | | | | | |
| HDDA (pph) | 0.20 | 0.20 | 0.50 | 0.20 | 0.20 | 0.20 | 0.35 |
| P125 (pph) | | | | 10.00 | | | |
| S 7125 (pph) | | | | | 10.00 | | |
| Aerosil R972 | 10.00 | | | | | | 2.00 |
| (pph) | | | | | | | |
| HTGO (pph) | | 10.00 | | | | | |
| GB K15 (pph) | | | | | | | 3.00 |

### Preparation of Example 1-Example 7 and Illustrative Example 8 (Ex 1-Ex 7 and IE 8)

The liquid precursor Example 1 to Example 7 and Illustrative Example 8 was coated on 600 micrometers gap on a lab coater, according to the method described in U.S. Pat. No. 4,818,610 (Zimmerman et al.) calculated from the substrate surface. The adhesive film was cured between two polyester film liners (“HOSTAPHAN 2SLK”, Mitsubishi Polyester Film GmbH, Wiesbaden, Germany). Curing was accomplished from both top and bottom side in a UV-curing station with a length of 300 cm at the line speed set to 0.70 in/mmn. The total radiation intensity irradiated cumulatively from top and bottom side was approximately 3 mW/cm².

### Preparation of the Multilayer Pressure Sensitive Adhesive Assemblies for Example 9-Example 14 (Ex 9-Ex 14)

The precursors of the pressure sensitive adhesive layer skin SL-1-SL-6 and of Example 9 foam, were superimposed onto each other in a lab coater, according to the method described in U.S. Pat. No. 4,818,610 (Zimmerman et al.). Hereby, the liquid precursor of the pressure sensitive adhesive skin layer (e.g., SL-1) was coated on the bottom of the foam core layer EX-9. The knife height setting was 120 μm for the first knife (for the pressure sensitive adhesive skin layer SL-1 to SL-6) and 620-640 μm for the second knife (for the polymeric foam core layer EX-9), both levels calculated from the substrate surface. Curing between two liners as described above for Examples 1 to 7 was accomplished from both top and bottom side in a UV-curing station with a length of 300 cm at the line speed set to 1.00 m/min. The total radiation intensity irradiated cumulatively from top and bottom was approximately 3 mW/cm².

### Results:

TABLE 4
Test Results for Examples 1-7 (Ex 1-Ex 7), Illustrative
Example 8 (IE 8), and Comparative Example 1 (VHB 4936)

| | | | | | | | | | VHB |
|---|---|---|---|---|---|---|---|---|---|
| | Ex 1 | Ex 2 | Ex 3 | Ex 4 | Ex 5 | Ex 6 | Ex 7 | IE 8 | 4936 |
| OLS | 1.98 | 3.79 | 2.69 | 2.6 | 3.31 | 2.74 | 4.12 | 2.14 | 1.00 |
| Adhesion, | | | | | | | | | |
| MPa | | | | | | | | | |
| Static Shear | 10000 | 10000 | 10000 | 618 | 10000 | 10000 | 10000 | 10000 | 12 |
| test value, | | | | | | | | | |
| min | | | | | | | | | |
| Complex | 1.92 | 1.39 | 2.25 | | | 2.01 | 3.14 | 0.74 | 0.42 |
| modulus | | | | | | | | | |
| @25° C., 1 | | | | | | | | | |
| Hz, Mpa | | | | | | | | | |
| Storage | 1.3 | 0.9 | 1.5 | | | 1.3 | 2 | 0.5 | 0.3 |
| modulus | | | | | | | | | |
| @25° C., 1 | | | | | | | | | |
| Hz, MPa | | | | | | | | | |

TABLE 5
Test Results for Examples 9-15 (Ex 9-Ex 15)

| | Ex 9 | Ex 10 | Ex 11 | Ex 12 | Ex 13 | Ex 14 | Ex 15 |
|---|---|---|---|---|---|---|---|
| Core | FL-9 | FL-9 | FL-9 | FL-9 | FL-9 | FL-9 | FL-9 |
| Skin | SL-1 | SL-2 | SL-3 | SL-4 | SL-5 | SL-6 | none |
| OLS | 2.08 | 2.05 | 2.23 | 1.93 | 1.80 | 1.95 | 2.05 |
| Adhesion | | | | | | | |
| on Al, MPa | | | | | | | |
| 90° Peel | 76 | 77 | 66 | 55 | 74 | 81 | 65 |
| adhesion | | | | | | | |
| on SS, | | | | | | | |
| N/cm | | | | | | | |

This disclosure is not limited to the above-described embodiments but is to be controlled by the limitations set forth in the following claims and any equivalents thereof.

1. An adhesive film comprising:
a first (meth)acrylate copolymer comprising:
at least 55 weight percent of linear or branched alkyl (meth)acrylate monomer units, based on the weight of the first (meth)acrylate copolymer;
from 15 weight percent to 40 weight percent of (meth)acrylic acid monomer units, based on the weight of the first (meth)acrylate copolymer, wherein if the first (meth)acrylate copolymer comprises 15 weight percent (meth)acrylic acid monomer units, the first (meth)acrylate copolymer comprises at least five weight percent monomer units of a high T_{g} monomer that when homopolymerized provides a homopolymer having a glass transition temperature of at least 50° C., based on the weight of the first (meth)acrylate copolymer; and
0.1 weight percent to 5 weight percent of monomer units of a crosslinking monomer having more than one (meth)acrylate group, based on the weight of the first (meth)acrylate copolymer,
wherein the adhesive film comprises not more than five percent by weight of a further (meth)acrylate copolymer comprising from 0.1 weight percent to 15 weight percent of (meth)acrylic acid monomer units, based on the weight of the further (meth)acrylate copolymer.

2. The adhesive film of claim 1, wherein the first (meth)acrylate copolymer comprises (meth)acrylic acid monomer units in an amount of greater than 15 weight percent, based on the weight of the first (meth)acrylate copolymer.

3. The adhesive film of claim 2, further comprising monomer units of a high T_{g} monomer that when homopolymerized provides a homopolymer having a glass transition temperature of at least 50° C.

4. The adhesive film of claim 1, wherein the adhesive film has a storage modulus of more than 0.5 megapascals as measured on a rheometer at 25° C. and 1 hertz.

5. The adhesive film of claim 1, having a thickness of at least 0.3 millimeters.

6. The adhesive film of claim 1, wherein the adhesive film is a foam.

7. The adhesive film of claim 6, comprising from two weight percent to 12 weight percent of at least one of polymeric microspheres or glass bubbles, based on the total weight of the adhesive film.

8. The adhesive film of claim 1, further comprising a second (meth)acrylate copolymer comprising from greater than 15 weight percent to 40 weight percent of (meth)acrylic acid monomer units, based on the weight of the second (meth)acrylate copolymer.

9. The adhesive film of claim 8, wherein the first (meth)acrylate copolymer is present in a range from 65 weight percent to 99 weight percent, and wherein the second (meth)acrylate copolymer is present in a range from 1 weight percent to 35 weight percent, based on the total weight of the adhesive film.

10. The adhesive film of claim 1, wherein the adhesive film is a multilayer adhesive assembly comprising a first layer of the first (meth)acrylate copolymer and a second adhesive layer adjacent to the first layer.

11. The adhesive film of claim 10, wherein the first layer of the first (meth)acrylate copolymer is a core of a skin-core-skin multilayer adhesive.

12. A process for manufacturing the adhesive film of claim 8, the process comprising:
incorporating the second (meth)acrylate copolymer into a curable precursor composition comprising the linear or branched alkyl (meth)acrylate monomer, the (meth)acrylic acid monomer, the crosslinking monomer, and a polymerization initiator; and
polymerizing the linear or branched alkyl (meth)acrylate monomer, the (meth)acrylic acid monomer, the crosslinking monomer to form the first (meth)acrylate copolymer in the presence of the second (meth)acrylate copolymer.

13. The adhesive film of claim 1, wherein the adhesive film adheres to a primed substrate surface when applied without the use of heat or radiation.

14. An adhesive system comprising a primer composition and the adhesive film of any one of claim 1.

15. The adhesive system of claim 14, wherein the primer composition comprises at least one of a polyamide, a polyurethane, or a polyacrylate.

16. The adhesive system of claim 15, wherein the primer composition comprises a polyamide and a polyacrylate.

17. The adhesive system of claim 14, wherein the adhesive film does not react with the primer composition to form covalent bonds.

18. The adhesive film of claim 1, wherein the linear or branched alkyl (meth)acrylate monomer units comprise at least one of 2-ethylhexyl (meth)acrylate, 2-propylheptyl (meth)acrylate, or iso-octyl (meth)acrylate units.

19. The adhesive film of claim 1, wherein the high T_{g} monomer comprises at least one of methyl methacrylate, ethyl methacrylate, n-propyl methacrylate, isopropyl methacrylate, n-butyl methacrylate, isobutyl methacrylate, sec-butyl methacrylate, tert-butyl acrylate, tert-butyl methacrylate, cyclohexyl methacrylate, isobornyl methacrylate, isobornyl acrylate, stearyl acrylate, stearyl methacrylate, phenyl acrylate, benzyl methacrylate, 3,3,5 trimethylcyclohexyl acrylate, 3,3,5 trimethylcyclohexyl methacrylate, tert-butyl cyclohexyl methacrylate, 2-phenoxyethyl methacrylate, N-octyl acrylamide, N-octyl methacrylamide, tetrahydrofurfuryl methacrylate, dihydrodicyclopentadienylacrylate, vinyl methyl ether, vinyl acetate, vinyl propionate, styrene, or alpha-methyl styrene.

20. The adhesive film of claim 1, wherein the high T_{g} monomer comprises at least one of methyl methacrylate, isobornyl methacrylate, isobornyl acrylate, or dihydrodicyclopentadienylacrylate.
